(19) United States
(12) Patent Application Publication
(10) Pub. No.: US 2018/0283940 A1
(43) Pub. Date: Oct. 4, 2018

(54) STRAY LIGHT INTERFERENCE REDUCTION DESIGN FOR CROSSED CZERNY-TURNER SPECTROMETERS

(71) Applicant: Ocean Optics, Inc., Largo, FL (US)

(72) Inventors: Jonathan Drewes, Oviedo, FL (US); Bryan Auz, Orlando, FL (US)

(21) Appl. No.: 15/920,680

(22) Filed: Mar. 14, 2018

Related U.S. Application Data
(60) Provisional application No. 62/478,679, filed on Mar. 30, 2017.

(51) Int. Cl. G01J 3/02; G01J 3/18

(52) U.S. Cl. CPC G01J 3/021; G01J 2003/1226; G01J 3/0208; G01J 3/18

(57) ABSTRACT

A spectrometer design offering good balance between resolution and throughput using just two aspheric toric mirrors and no detector lens and having improved stray light interference reduction through use of light traps and light absorbing coatings is disclosed.

### CROSS-REFERENCE TO RELATED APPLICATION

The present application claims the benefit of previously filed co-pending Provisional Patent Application Ser. No. 62/478,679, filed on Mar. 30, 2017.

### FIELD OF THE INVENTION

This invention belongs to the field of design and manufacture of optical systems. More specifically it is a spectrometer design offering good balance between resolution and throughput using just two aspheric toric mirrors and no detector lens and having improved stray light interference reduction.

### BACKGROUND OF THE INVENTION

A spectrometer is a device capable of separating an input light source into its constituent spectral components and separately measuring the intensity of each such component. The optical design development process for a spectrometer requires optimal balance between the following key optical system parameters for a general purpose spectrometer:

Spectral resolution;
Throughput (etendue);
Stray light;
Optical component simplicity;
System configurability; and,
Dimensional compactness.

The primary achievement of this design is the substantial improvement of the first 4 of these attributes while maintaining the last two. These six attributes are used in the optical design merit function (MF) that has been optimized upon, i.e., the optical performance of the spectrometer has been improved compared to existing standard Crossed Czerny-Turner (CCT) design types, which typically use spherical mirrors.

Spectrometer systems that meet the above goals are not known to exist in the marketplace, as judged by their stated specifications and known design detail. As technology advances for all spectrometer applications, the need for improved optical performance also increases, which has been the motivation for this design development. An appreciation of the advantages these features represent when compared with previous designs can be derived from consideration of the following drawings and description of the invention.

### BRIEF SUMMARY OF THE INVENTION

This invention is a spectrometer design offering good balance between resolution and throughput using just two aspheric toric mirrors and no detector lens and having improved stray light interference reduction.

### BRIEF DESCRIPTION OF THE DRAWINGS

For a fuller understanding of the nature and objects of the invention, reference should be made to the following detailed description, taken in connection with the accompanying drawings, in which:

FIG. 1 shows an perspective view of the optical design layout; and,

FIG. 2 shows an overhead view of the spectrometer design layout.

### DESCRIPTION OF THE PREFERRED EMBODIMENT

Making the optical improvements stated in this disclosure while maintaining the system size and configurability of the spectrometer is the most novel/unique aspect of this invention. The dominant necessary efforts to yield this design have been: Surveying, studying, and modeling all (or many) existing and known spectrometer optical design types in order to select the most optimal type, the Crossed Czerny-Turner, for the merit function; using the Zemax optical design and modeling program to construct and evaluate numerous optical design types using a carefully developed optimization merit function (this is something explicitly specified in Zemax) to arrive at the present design; utilizing the aspheric toroid shape for the two system mirrors, 900 um tall detector array, and removing the requirement to use a cylindrical lens near the detector to achieve the optimal merit function; using Zemax to model where the stray light (SL) is in the system and then designing light trap structures to reduce its magnitude. Also, the use of broadband light absorbing coatings within the optical bench is employed to reduce stray light.

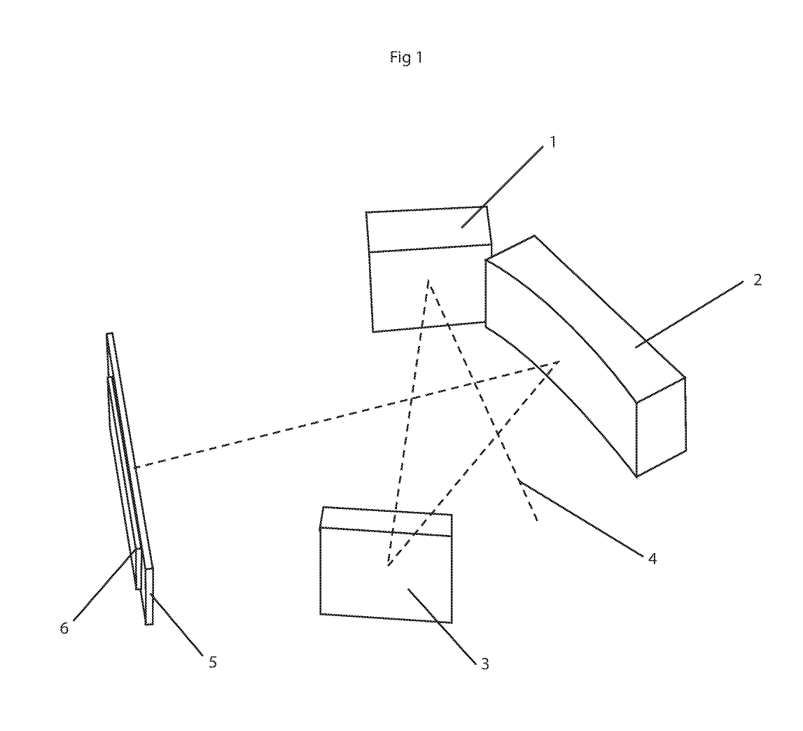

More specifically, the optical design layout showing a specific ray-trace and the size and locations of a first aspheric toric mirror (1), a second aspheric toric mirror (2), a grating (3), an entrance slit (4), a detector window (5), and a detector (6) for the visible to near infrared configuration of the preferred embodiment at ideal placements (no tolerances) is shown in FIG. 1.

Additional specific and numerous optical design considerations are taken into account in the development of the optical design shown in FIG. 1 as are known in the art. Some of the more important ones are: The dimensions of the detector active area and pixel size; dimensions of the input fiber core; the numerical aperture of the fiber; dimensions of the input slit; the range of ideal spectral ranges desired for the various spectrometer configurations to be built; and, the fabrication methods and associated specifications and tolerances available to produce the desired mirror shapes as are well known by those skilled in the art.

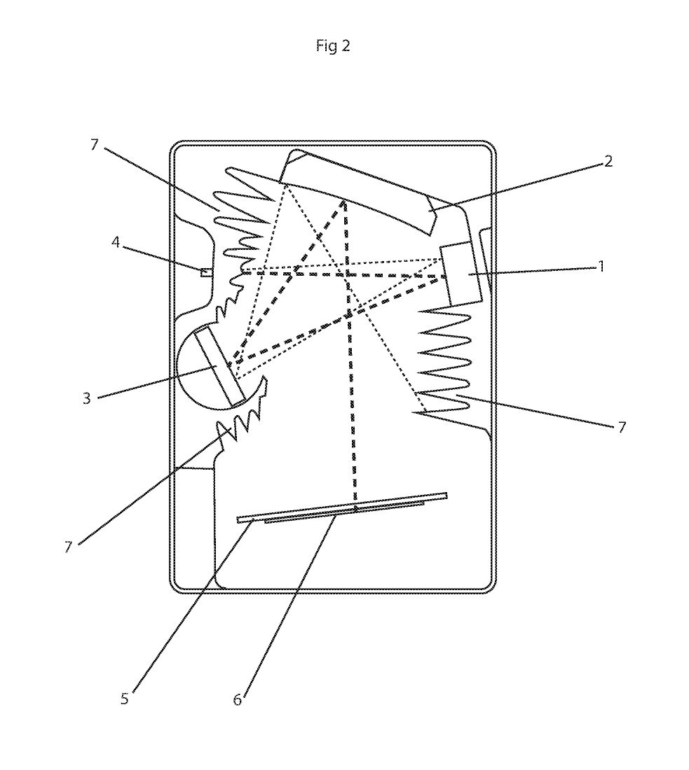

What is further disclosed herein in FIG. 2 is the basic optical design layout including light traps (also known as beam dumps) (7) in three primary locations placed around the CCT optical cavity which are used to absorb (not reflect back) light primarily coming from the other diffracted orders from the diffraction grating (3). These are used in conjunction with a specific light absorbing coating that is applied to the optical cavity. Acktar black and black nano-structure coatings from Surrey Nano Systems are examples of these coatings and are used in the preferred embodiment.

Since certain changes may be made in the above described optical system and spectrometer design features without departing from the scope of the invention herein involved, it is intended that all matter contained in the description thereof or shown in the accompanying figures shall be interpreted as illustrative and not in a limiting sense.

What is claimed is:

1. A Crossed Czerny-Turner spectrometer system having improved stray light interference reduction comprising;
a spectrometer housing having an optical cavity;
said spectrometer housing containing an entrance slit;
said entrance slit directing a light beam to a first aspheric toric mirror in said optical cavity;
said first aspheric toric mirror further directing said light beam to a grating in said optical cavity;
said grating further directing said light beam to a second aspheric toric mirror in said optical cavity;
said second aspheric toric mirror directing light to a detector in said optical cavity;
one or more light traps located within said optical cavity;
wherein said light traps absorb stray light coming from said grating; and,
said optical cavity coated with a light absorbing coating.
